(19) United States
(12) Patent Application Publication
(10) Pub. No.: US 2025/0388087 A1
(43) Pub. Date: Dec. 25, 2025

(54) CHARGING DEVICE, METHOD FOR CONTROLLING CHARGING DEVICE, AND COMPUTER-READABLE MEDIUM

(71) Applicant: Panasonic Automotive Systems Co., Ltd., Kanagawa (JP)

(72) Inventors: Atsushi IISAKA, Kanagawa (JP); Tetsuya ISHIGURO, Kanagawa (JP); Takashi NAKAZAWA, Kanagawa (JP)

(73) Assignee: Panasonic Automotive Systems Co., Ltd., Kanagawa (JP)

(21) Appl. No.: 19/233,940

(22) Filed: Jun. 10, 2025

(30) Foreign Application Priority Data
Jun. 24, 2024 (JP) 2024-100964

(51) Int. Cl. B60L 3/04; B60L 53/20

(52) U.S. Cl. CPC B60L 3/04; B60L 53/20; B60L 2210/30; B60L 2270/20

(57) ABSTRACT

A charging device includes: an inrush current prevention circuit including a resistor having a first end connected to a first input terminal, and a relay having a first end connected to the first input terminal, and a second end connected to a second end of the resistor, and that opens while power is not supplied; a voltage detector that detects a voltage between the second end of the resistor and a second input terminal; and a charging circuit that converts AC power supplied via the inrush current prevention circuit into DC power. A control circuit determines that the relay fails when the voltage after a predetermined time has elapsed after control to cause the relay to be closed is a voltage corresponding to a voltage drop of the resistor with respect to a voltage of external AC power supplied to the input terminals.

### CROSS-REFERENCE TO RELATED APPLICATIONS

This application is based upon and claims the benefit of priority from Japanese Patent Application No. 2024-100964, filed Jun. 24, 2024, the entire contents of which are incorporated herein by reference.

### FIELD

The present disclosure relates to a charging device, a method for controlling a charging device, and a computer-readable medium.

### BACKGROUND

Conventionally, an in-vehicle charging device that charges a battery from an external AC power source is known.

In the conventional in-vehicle charging device, an inrush current prevention resistor for preventing an inrush current from flowing to the in-vehicle charging device when the in-vehicle charging device is connected to the external AC power source and a relay (bypass relay) for preventing an AC current from flowing to the inrush current prevention resistor during actual charging are arranged in parallel with the inrush current prevention resistor.

A related technique is described in JP 2021-016276 A.

However, in the conventional in-vehicle charging device described above, after a smoothing capacitor inside the in-vehicle charging device is charged by connecting the in-vehicle charging device to the external AC power source, control is performed to turn on the relay in order to supply power from the external AC power source without passing through the inrush current prevention resistor.

Meanwhile, in a voltage sensor that detects the voltage of the smoothing capacitor, an AC voltage is detected even in a case where the bypass relay cannot be turned on due to a failure or the like, and thus it is not possible to detect that the relay cannot be turned on.

As a result, there is a problem that the charging cannot be performed via the relay without the inrush current prevention resistor, whereby the charging is not effectively performed.

The present invention has been made in view of the above problems, and an object of the present invention is to provide a charging device, a method for controlling a charging device, and a computer-readable medium capable of reliably detecting a failure of a relay provided in parallel with an inrush prevention resistor without increasing the number of components.

### SUMMARY

A charging device according to the present disclosure includes an inrush current prevention circuit, a voltage detector, a control circuit, and a charging circuit. The inrush current prevention circuit prevents an inrush current. The inrush current prevention circuit includes a pair of input terminals, a resistor, and a relay. External AC power is supplied to the input terminals. The resistor has a first end connected to a first input terminal of the input terminals. The relay has a first end connected to the first input terminal of the input terminals, and a second end connected to a second end of the resistor. The voltage detector detects a voltage between the second end of the resistor and a second input terminal of the input terminals. The control circuit performs control of the relay based on the voltage of the voltage detector. The charging circuit converts AC power supplied via the inrush current prevention circuit into DC power and performs charging of a secondary battery. The relay is in an open state in a state where power is not supplied to the input terminal. The control circuit determines that the relay fails when determining that a voltage detected by the voltage detector after a predetermined time has elapsed since control to cause the relay to be in a closed state has been performed is a voltage corresponding to a voltage drop of the resistor with respect to a voltage of the external AC power.

### BRIEF DESCRIPTION OF THE DRAWINGS

FIG. 1 is a schematic explanatory diagram of an electric vehicle charging system of an embodiment;

FIG. 2 is a schematic configuration diagram of an in-vehicle charging device;

FIG. 3 is an operation explanatory diagram of a case where supply power is single-phase AC power;

FIG. 4 is an operation explanatory diagram of a case where the supply power is three-phase AC power; and

FIG. 5 is an operation flowchart of embodiments.

### DETAILED DESCRIPTION

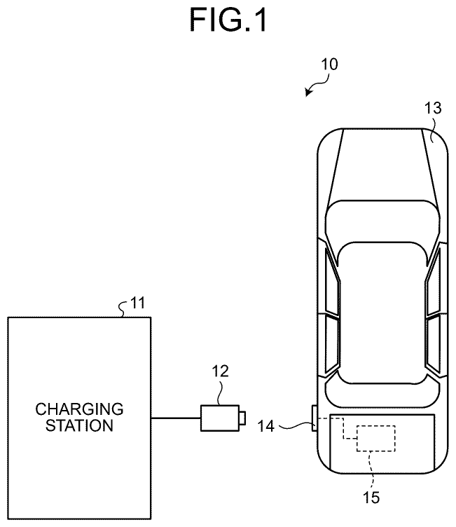

FIG. 1 is a schematic explanatory diagram of an electric vehicle charging system of an embodiment.

The electric vehicle charging system 10 of the embodiment includes a charging station 11, a charging plug 12, and an electric vehicle 13.

The electric vehicle 13 includes a charging receptacle 14 and an in-vehicle charging device 15.

The charging station 11 is configured to receive power supply from a commercial power source and supply AC power to the electric vehicle 13 to charge an in-vehicle battery of the electric vehicle 13.

Since the in-vehicle charging device 15 of the electric vehicle 13 is AC power supplied via the charging receptacle 14, the in-vehicle charging device performs AC/DC power conversion to charge the in-vehicle battery of the electric vehicle 13.

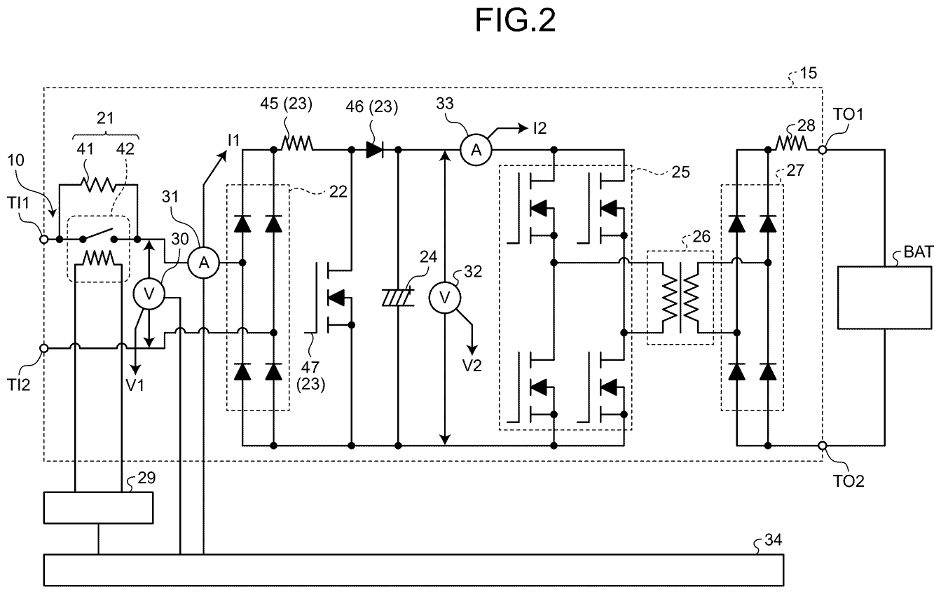

FIG. 2 is a schematic configuration diagram of the in-vehicle charging device.

The in-vehicle charging device 15 includes input terminals TI1 and TI2, an inrush current prevention circuit 21, a first rectifier circuit 22, a power factor correction circuit (PFC) 23, a smoothing capacitor 24, an inverter 25, a transformer 26, a second rectifier circuit 27, an inductor 28, output terminals TO1 and TO2, a relay drive circuit 29, a first voltage detector 30, a first current detector 31, a second voltage detector 32, a second current detector 33, and a controller 34.

In the above configuration, the input terminals TI1 and TI2 are electrically connected to the terminal of the charging receptacle 14 to which the charging plug 12 is connected, and power is supplied.

The first rectifier circuit 22, the power factor correction circuit (PFC) 23, the smoothing capacitor 24, the inverter 25, the transformer 26, the second rectifier circuit 27, and the inductor 28 constitute a charging circuit.

The inrush current prevention circuit 21 is a circuit that prevents a current for precharging the smoothing capacitor 24 from rapidly flowing at the start of charging.

The inrush current prevention circuit 21 includes an inrush current prevention resistor (inrush prevention resistor) 41 and a relay 42.

Here, one end of the inrush current prevention resistor 41 is connected to the input terminal TI1 and prevents a current for precharging the smoothing capacitor 24 from being supplied as an inrush current when input of AC power of a predetermined voltage from the input terminal TI1 is started.

The relay 42 is connected in parallel with the inrush current prevention resistor 41, is closed after completion of the precharging of the smoothing capacitor 24, and supplies AC power to be subjected to power conversion to the subsequent circuit.

The first rectifier circuit 22 is configured as a diode bridge, converts the input AC power into DC power, and supplies the DC power to the power factor correction circuit 23.

The power factor correction circuit 23 performs control so that the power factor (ratio of active power to apparent power) of AC power supplied from the inrush current prevention circuit 21 approaches 1.

The power factor correction circuit 23 includes an inductor (coil) 45 that has one end connected to the inrush current prevention resistor 41 and is connected in series to the inrush current prevention resistor 41, a diode 46 that has an anode connected to the other end of the inductor 45, and a switching transistor 47 that has one end connected to the anode of the diode 46.

The smoothing capacitor 24 operates to smooth a DC voltage output from the power factor correction circuit 23 and supply DC power of a predetermined constant voltage to the subsequent circuit.

The inverter 25 converts DC power of a predetermined voltage supplied via the smoothing capacitor 24 into AC power and outputs the AC power.

The transformer 26 converts a voltage of the input AC power into a predetermined output voltage according to the winding ratio between a primary winding and a secondary winding, and supplies the predetermined output voltage to the second rectifier circuit 27.

The second rectifier circuit 27 is configured as a diode bridge, converts the AC power transformed by the transformer 26 into DC power, and supplies the DC power to an in-vehicle battery BAT to be charged via the output terminals TO1 and TO2 to perform charging.

The relay drive circuit 29 is a circuit that drives the relay 42 to perform operation of turning on/off the relay 42 under the control of the controller 34.

The first voltage detector 30 detects an AC voltage between the other end of the inrush current prevention resistor 41 and the second input terminal TI2 and outputs the AC voltage to the controller 34 as a first voltage detection signal V1.

The first current detector 31 detects an alternating current flowing from the other end of the inrush current prevention resistor 41 toward the smoothing capacitor 24 side and outputs the alternating current to the controller 34 as a first current detection signal I1.

The second voltage detector 32 detects a voltage at the terminal of the smoothing capacitor 24 (DC voltage) and outputs the voltage to the controller 34 as a second voltage detection signal V2.

The second current detector 33 detects a direct current flowing from the power factor correction circuit 23 to the inverter 25 side and outputs the direct current to the controller 34 as a second current detection signal 12.

The controller 34 performs control to cause the relay 42 to be in an on state via the relay drive circuit 29 after the charging receptacle 14 is connected to the in-vehicle charging device 15, and a predetermined precharging time has elapsed. When detecting that the relay 42 has not transitioned to the on state based on the input first current detection signal I1 and the first voltage detection signal V1, a relay off-sticking abnormality has occurred, and the controller 34 performs processing such as stopping power supply to protect the inrush current prevention resistor 41.

Note that a specific method for detecting that the relay 42 has not transitioned to the on state, that is, the occurrence of the relay off-sticking abnormality, will be described in detail later.

In addition, the controller 34 performs control to cause the relay 42 to be in the on state via the relay drive circuit 29 and controls the power factor correction circuit 23 and the inverter 25 based on the second current detection signal I1 and the second voltage detection signal V2 to control the power supplied to the transformer 26 side when detecting that the relay 42 has transitioned to the on state based on the input first current detection signal I1 and first voltage detection signal V1.

Here, the principle of detecting the relay off-sticking abnormality will be described.

### (1) Case Where Supply Power is Single-Phase AC Power

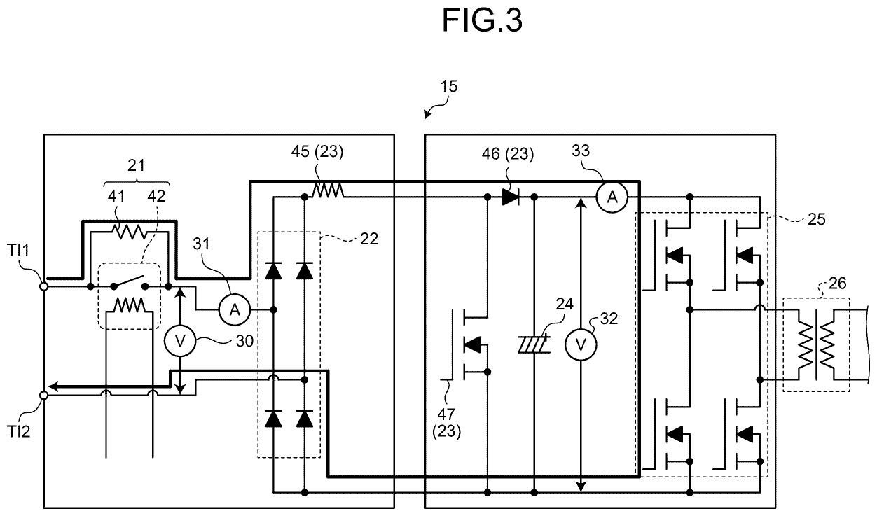

FIG. 3 is an operation explanatory diagram of a case where the supply power is single-phase AC power.

In FIG. 3, a thick arrow schematically illustrates the flow of a charging current via the inrush current prevention resistor 41 when the precharged relay 42 is in an off state.

In this case, a voltage of the AC power (single-phase AC power) supplied from the charging station 11 in a case where no current is flowing is ACVpre.

When the charging receptacle 14 is connected to the in-vehicle charging device 15, the charging station 11 receives power supply from a commercial power source and starts supplying the AC power of the voltage ACVpre.

As a result, the AC power is supplied to the first rectifier circuit via the inrush current prevention resistor 41.

The first rectifier circuit 22 performs AC/DC conversion to charge the smoothing capacitor 24.

At this time, when a voltage detected by the first voltage detector 30 is ACVchg, the resistance value of the inrush current prevention resistor 41 is R1, and the current detected by the first current detector 31 is ACI, the following equation is established.

$$ACVpre \approx ACVchg + R 1 \cdot ACI$$

In other words, in a case where a voltage drop caused by the inrush current prevention resistor 41 is continuously detected during the charging, it is recognized that the relay off-sticking abnormality has occurred.

### (2) Case Where Supply Power is Three-Phase AC Power

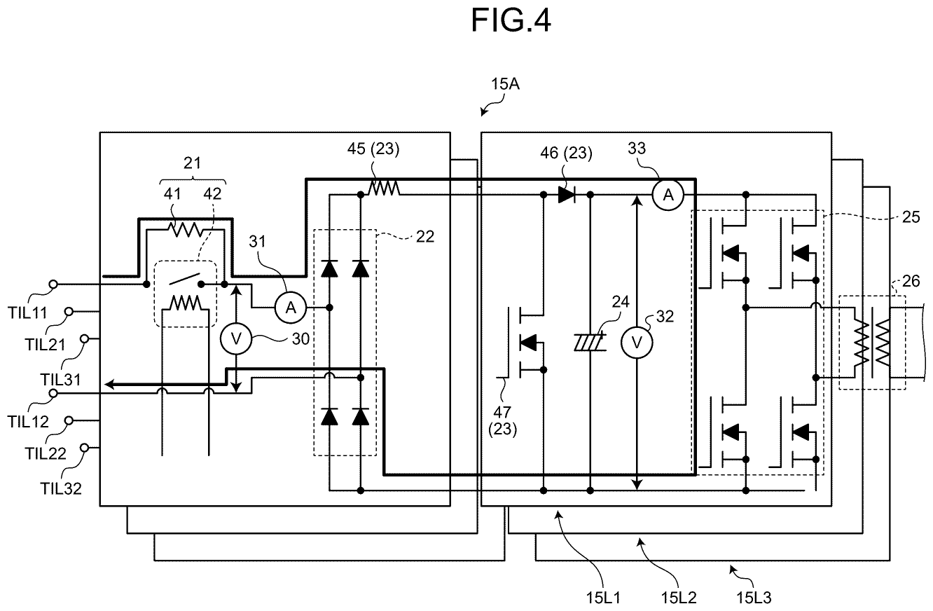

FIG. 4 is an operation explanatory diagram of a case where the supply power is three-phase AC power.

In this case, in each of phases L1 to L3 constituting the three-phase AC power, the same circuit configuration is provided without the controller in the configuration of the in-vehicle charging device 15 illustrated in FIG. 2, and one controller common to all the phases is provided.

More specifically, an in-vehicle charging device 15A to which the three-phase AC power is input has the same configuration as the in-vehicle charging device 15, and adopts a configuration in which a first charging unit 15L1 corresponding to the phase L1, a second charging unit 15L2 corresponding to the phase L2, and a third charging unit 15L3 corresponding to the phase L3 are connected in parallel.

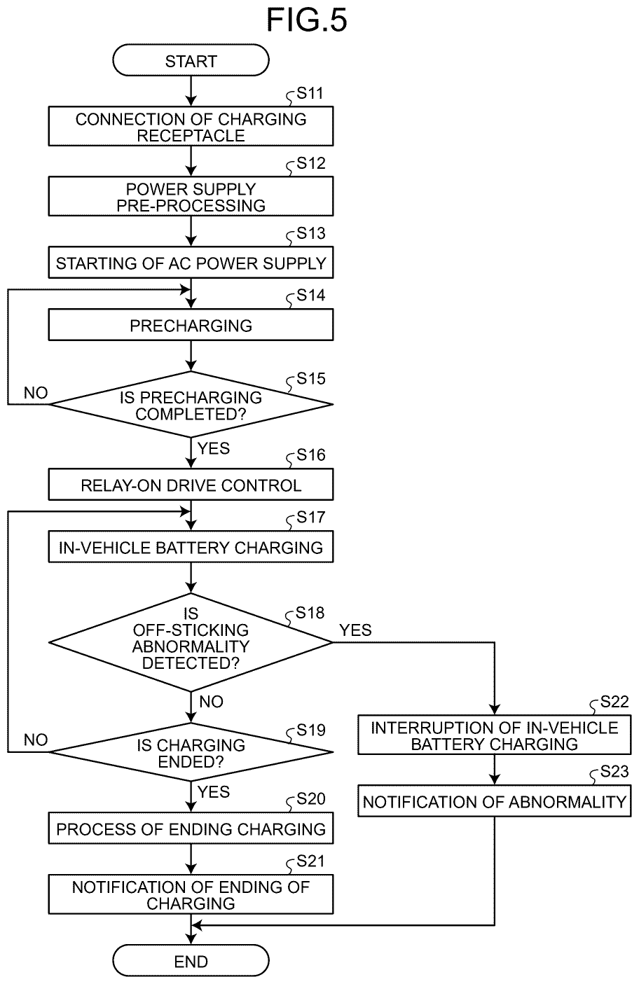

In FIG. 5, a thick arrow schematically illustrates the flow of a charging current via the inrush current prevention resistor 41 when the precharged relay 42 is in an off state.

In the above configuration, in a case where all phases L1 to L3 are normally operating, the following equation

$$L 1 \_ACVchg \approx L2\_ACVchg \approx L3\_ACVchg$$

is established, where a voltage corresponding to the phase L1 detected by the first voltage detector 30 corresponding to the phase L1 is L1_ACVchg, a voltage corresponding to the phase L2 detected by the first voltage detector 30 corresponding to the phase L2 is L2_ACVchg, and a voltage corresponding to the phase L3 detected by the first voltage detector 30 corresponding to the phase L3 is L3_ACVchg, when the first rectifier circuit 22 corresponding to each of the phases charges the smoothing capacitor 24 by performing the AC/DC conversion.

On the other hand, in a case where the relay 42 corresponding to the phase L1 is in the relay off-sticking abnormal state, the following equation is established, where the resistance value of the inrush current prevention resistor 41 of each of the phases L1 to L3 is R1, and the current detected by the first current detector 31 corresponding to the phase L1 is L1_ACI.

$$\begin{matrix}L2\_ACVchg \approx L3\_ACVchg \\ \approx L 1 \_ACVchg + R 1 \cdot L1\_ACI\end{matrix}$$

Therefore, in a case where the voltage drop caused by the inrush current prevention resistor 41 corresponding to the phase L1 during charging is continuously detected, it is recognized that the relay off-sticking abnormality has occurred in the relay 42 corresponding to the phase L1.

Next, operations of embodiments will be described.

### (1) First Embodiment

In the first embodiment, the supply power is single-phase AC power.

FIG. 5 is an operation flowchart of the embodiment.

It is assumed that the relay 42 is in an off state in a state where the charging receptacle 14 is not connected to the in-vehicle charging device 15.

In the controller 34, the charging receptacle 14 is connected to the in-vehicle charging device 15 (Step S11), a controller (not illustrated) on the charging station 11 side notifies of an allowable current value, and power supply pre-processing is performed in which the controller 34 requests power supply to the charging station 11 (Step S12).

When the power supply pre-processing is completed, AC power is supplied from the charging station 11 via the charging receptacle 14 (Step S13).

As a result, an alternating current flows through the inrush current prevention resistor 41 by the AC power supplied via the input terminals TI1 and TI2, and the smoothing capacitor 24 is precharged (Step S14).

More specifically, the AC power supplied via the inrush current prevention resistor 41 is rectified by the first rectifier circuit 22 to become DC power.

The smoothing capacitor 24 is precharged with the DC power output from the first rectifier circuit 22 via the power factor correction circuit 23.

At this time, the second voltage detector 32 measures a voltage between the terminals of the smoothing capacitor 24, and outputs the second voltage detection signal V2 to the controller 34.

In addition, the first voltage detector 30 measures a voltage at one end of the inrush current prevention resistor 41 (corresponding to a voltage between input terminals of the first rectifier circuit 22) and outputs the first voltage detection signal V1 to the controller 34.

In parallel with this, the controller 34 determines whether the voltage between the terminals of the smoothing capacitor 24 corresponding to the second voltage detection signal V2 reaches a predetermined precharge voltage, and the precharging is completed (Step S15).

In the determination in Step S15, in a case where the voltage between the terminals of the smoothing capacitor 24 corresponding to the second voltage detection signal V2 has not reached the predetermined precharge voltage yet, and the precharging has not been completed (Step S15: No), a standby state is set.

In the determination in Step S15, in a case where the voltage between the terminals of the smoothing capacitor 24 corresponding to the second voltage detection signal V2 has reached the predetermined precharge voltage, and the precharging has been completed (Step S15: Yes), the controller 34 outputs a relay drive control signal SRD to the relay drive circuit 29 in order to switch the current path of the inrush current prevention circuit from the inrush current prevention resistor 41 to the relay 42 (Step S16).

As a result, the relay drive circuit 29 operates to cause a current to flow through a coil constituting the relay 42, whereby the relay 42 transitions to the on state.

Subsequently, the controller 34 performs an operation of charging the in-vehicle battery BAT (Step S17).

Then, in a case where the voltage detected by the first voltage detector 30 is ACVchg, the resistance value of the inrush current prevention resistor 41 is R1, and the current detected by the first current detector 31 is ACI, the controller 34 determines whether the following Equation (1) is established (Step S18).

$$ACVpre \approx ACVchg + R 1 \cdot ACI \qquad ( 1 )$$

In the determination in Step S18, in a case where Equation (1) is established (Step S18: Yes), since the relay 42 has an off-sticking abnormality, and the relay 42 cannot transition to the on state, the controller 34 interrupts the charging to prevent the inrush current prevention resistor 41 from being damaged due to an overcurrent (Step S22).

Then, the controller 34 notifies the charging station 11 of the abnormality indicating that an on-sticking abnormality has occurred in the relay 42 (Step S23), and ends the processing.

On the other hand, in the determination in Step S18, in a case where Equation (1) is not established, that is,

$$ACVpre \approx ACVchg \qquad ( 2 )$$

is established (Step S18: No), the controller 34 determines whether the charging of the in-vehicle battery BAT has been completed (Step S19). In other words, it is determined whether the in-vehicle battery BAT has reached a predetermined charging amount.

In the determination in Step S19, in a case where the charging has not ended yet (Step S19: No), the controller 34 shifts the process to Step S17 again and continues the charging of the in-vehicle battery BAT (Step S17).

On the other hand, in the determination in step S19, in a case where the in-vehicle battery BAT has reached the predetermined charging amount, and the charging of the in-vehicle battery BAT has ended (Step S19: Yes), the controller 34 performs a process of ending the charging such as cutting off the current supply (Step S20), and notifies the charging station 11 of the ending of the charging indicating that the charging has been normally completed, thus ending the process (Step S21).

As described above, according to the first embodiment, it is possible to reliably detect a failure of a bypass relay provided in parallel with an inrush current prevention resistor without increasing the number of components, and it is possible to avoid a failure due to an overcurrent flowing through the inrush current prevention resistor or the like.

### (2) Second Embodiment

In the second embodiment, the supply power is three-phase AC power.

FIG. 5 is an operation flowchart of the embodiment.

It is assumed that the relay 42 is in an off state in a state where the charging receptacle 14 is not connected to the in-vehicle charging device 15.

In the controller 34, the charging receptacle 14 is connected to the in-vehicle charging device 15 (Step S11), a controller (not illustrated) on the charging station 11 side notifies of power supply information (voltage, current, and the like) and the fact that power supply has started, and power supply pre-processing is performed in which the controller 34 responds by accepting the power supply (Step S12).

When the power supply pre-processing is completed, three-phase AC power is supplied from the charging station 11 via the charging receptacle 14 (Step S13).

In the following description, the phase L1 among the three phases L1, L2, and L3 constituting the three-phase AC power will be described as an example.

Due to the AC power supplied via input terminals TIL11 and TIL12 of the first charging unit 15L1 corresponding to the phase L1 constituting the three-phase AC power, an alternating current flows through the inrush current prevention resistor 41, and the smoothing capacitor 24 is precharged (Step S14).

More specifically, the AC power supplied via the inrush current prevention resistor 41 is rectified by the first rectifier circuit 22 to become DC power.

The smoothing capacitor 24 is precharged with the DC power output from the first rectifier circuit 22 via the power factor correction circuit 23.

At this time, the second voltage detector 32 measures a voltage between the terminals of the smoothing capacitor 24, and outputs the second voltage detection signal V2 to the controller 34.

In addition, the first voltage detector 30 measures a voltage at one end of the inrush current prevention resistor 41 (corresponding to a voltage between input terminals of the first rectifier circuit 22) and outputs the first voltage detection signal V1 to the controller 34.

In parallel with this, the controller 34 determines whether the voltage between the terminals of the smoothing capacitor 24 corresponding to the second voltage detection signal V2 reaches a predetermined precharge voltage, and the precharging is completed (Step S15).

In the determination in Step S15, in a case where the voltage between the terminals of the smoothing capacitor 24 corresponding to the second voltage detection signal V2 has not reached the predetermined precharge voltage yet, and the precharging has not been completed (Step S15: No), a standby state is set.

In the determination in Step S15, in a case where the voltage between the terminals of the smoothing capacitor 24 corresponding to the second voltage detection signal V2 has reached the predetermined precharge voltage, and the precharging has been completed (Step S15: Yes), the controller 34 outputs a relay drive control signal SRD to the relay drive circuit 29 in order to switch the current path of the inrush current prevention circuit from the inrush current prevention resistor 41 to the relay 42 (Step S16).

As a result, the relay drive circuit 29 operates to cause a current to flow through a coil constituting the relay 42, whereby the relay 42 transitions to the on state.

Subsequently, the controller 34 performs an operation of charging the in-vehicle battery BAT (Step S17).

Then, in a case where a voltage detected by the first voltage detector 30 of the first charging unit 15L1 is L1_ACVchg, a voltage detected by the first voltage detector 30 of the second charging unit 15L2 is L2_ACVchg, a voltage detected by the first voltage detector 30 of the third charging unit 15L3 is L3_ACVchg, the resistance value of each inrush current prevention resistor 41 is R1, and the current detected by the first current detector 31 corresponding to the phase L1 is L1_ACI, the controller 34 determines whether the following Equation (2-1) is established (Step S18).

$$\begin{matrix}L2\_ACVchg \approx L3\_ACVchg \\ \approx L 1 \_ACVchg + R 1 \cdot L1\_ACI\end{matrix} \qquad ( 2 - 1 )$$

In the determination in Step S18, in a case where Equation (2-1) is established (Step S18: Yes), since the relay 42 of the first charging unit 15L1 has an off-sticking abnormality, and the relay 42 cannot transition to the on state, the controller 34 interrupts the charging to prevent the inrush current prevention resistor 41 of the first charging unit 15L1 from being damaged due to an overcurrent (Step S22).

Similarly, in a case where the current detected by the first current detector 31 corresponding to the phase L2 is L2_ACI, the controller 34 determines whether the following Equation (2-2) is established (Step S18).

$$\begin{matrix}L1\_ACVchg \approx L3\_ACVchg \\ \approx L 2 \_ACVchg + R 1 \cdot L2\_ACI\end{matrix} \qquad ( 2 - 2 )$$

In the determination in Step S18, in a case where Equation (2-2) is established (Step S18: Yes), since the relay 42 of the second charging unit 15L2 has an off-sticking abnormality, and the relay 42 cannot transition to the on state, the controller 34 interrupts the charging to prevent the inrush current prevention resistor 41 of the second charging unit 15L2 from being damaged due to an overcurrent (Step S22).

Similarly, in a case where the current detected by the first current detector 31 corresponding to the phase L3 is L3_ACI, the controller 34 determines whether the following Equation (2-3) is established (Step S18).

$$\begin{matrix}L1\_ACVchg \approx L2\_ACVchg \\ \approx L 3 \_ACVchg + R 1 \cdot L3\_ACI\end{matrix} \qquad ( 2 - 3 )$$

In the determination in Step S18, in a case where Equation (2-3) is established (Step S18: Yes), since the relay 42 of the third charging unit 15L3 has an off-sticking abnormality, and the relay 42 cannot transition to the on state, the controller 34 interrupts the charging to prevent the inrush current prevention resistor 41 of the third charging unit 15L3 from being damaged due to an overcurrent (Step S22).

Although the case where the relay 42 of the charging unit corresponding to any one of the phases among the charging units 15L1 to 15L3 has the off-sticking abnormality is described above, in a case where the relay 42 of a charging unit corresponding to two phases or all phases has the off-sticking abnormality, the voltage of the corresponding phase is a value including the product of the resistance value of the inrush current prevention resistor 41 and the current detected by the first current detector 31 corresponding to the phase in which the sticking abnormality has occurred, and thus the abnormality can be detected in a similar manner.

Therefore, the controller 34 notifies the charging station 11 of the abnormality indicating that the on-sticking abnormality has occurred in the relay 42 of the charging unit corresponding to the phase in which the abnormality is detected (Step S23), and ends the processing.

On the other hand, in the determination in Step S18, in a case where none of Equations (2-1) to (2-3) is established, that is,

$$L 1 \_ACVchg \approx L2\_ACVchg \approx L3\_ACVchg \qquad ( 3 )$$

is established (Step S18: No), the controller 34 determines whether the charging of the in-vehicle battery BAT has ended (Step S19). In other words, it is determined whether the in-vehicle battery BAT has reached a predetermined charging amount.

In the determination in Step S19, in a case where the charging has not ended yet (Step S19: No), the controller 34 shifts the process to Step S17 again and continues the charging of the in-vehicle battery BAT (Step S17).

On the other hand, in the determination in step S19, in a case where the in-vehicle battery BAT has reached the predetermined charging amount, and the charging of the in-vehicle battery BAT has ended (Step S19: Yes), the controller 34 performs a process of ending the charging such as cutting off the current supply (Step S20), and notifies the charging station 11 of the ending of the charging indicating that the charging has been normally completed, thus ending the process (Step S21).

As described above, according to the second embodiment, it is possible to reliably detect a failure of a bypass relay provided in parallel with an inrush current prevention resistor without increasing the number of components, and it is possible to avoid a failure due to an overcurrent flowing through the inrush current prevention resistor or the like.

Although the case where the charging is interrupted when any charging unit among the charging units 15L1 to 15L3 detects the relay off-sticking abnormality is described above, the charging unit in which no abnormality is detected can be charged, thus reducing charging power and extending the time consumed until the completion of the charging, but the device can be configured so that the charging can be continuously performed. In this case, after notifying the charging station 11 of the abnormality, the controller 34 may notify the charging station that the time required for the charging is extended.

As described above, according to each embodiment, it is possible to reliably detect the failure of the relay provided in parallel with the inrush current prevention resistor without increasing the number of parts, to prevent a failure of the inrush current prevention resistor and eventually the charging device, and to improve convenience for a user.

In addition, the processing and control described as being performed by a plurality of devices in the embodiment may also be realized by being integrated in one device. Conversely, the processing and control described as being performed by one device can be realized by coordination among a plurality of devices.

The controller functioning as a control unit in the above-described embodiments includes a control device such as an MPU, a storage device such as a read only memory (ROM) and a RAM, and an input device such as an operation switch, and has a hardware configuration using an ordinary computer.

The program executed by the controller functioning as the control unit in the present embodiment can be provided by being recorded as a file in an installable format or an executable format in a semiconductor storage device such as a USB memory or an SSD, or a computer-readable recording medium such as a digital versatile disk (DVD).

In addition, the program executed by the controller functioning as the control unit in the present embodiment may be stored on a computer connected to a network such as Internet and provided by being downloaded via the network. Furthermore, the program executed by the controller functioning as the control unit in the present embodiment may be provided or distributed via a network such as Internet.

Moreover, the program of the controller that functions as the control unit in the present embodiment may be provided by being incorporated in a ROM or the like in advance.

According to the charging device of the present disclosure, it is possible to reliably detect a failure of the relay provided in parallel with the inrush current prevention resistor without increasing the number of components, and to prevent failure of the inrush current prevention resistor and eventually the charging device.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A charging device comprising:
an inrush current prevention circuit for preventing an inrush current, the inrush current prevention circuit including a pair of input terminals to which external AC power is supplied, a resistor having a first end connected to a first input terminal of the input terminals, and a relay having a first end connected to the first input terminal of the input terminals, and a second end connected to a second end of the resistor;
a voltage detector that detects a voltage between the second end of the resistor and a second input terminal of the input terminals;
a control circuit that performs control of the relay based on the voltage of the voltage detector; and
a charging circuit that converts AC power supplied via the inrush current prevention circuit into DC power and performs charging of a secondary battery, wherein
the relay is in an open state in a state where power is not supplied to the input terminals, and
the control circuit determines that the relay fails when determining that a voltage detected by the voltage detector after a predetermined time has elapsed since control to cause the relay to be in a closed state has been performed is a voltage corresponding to a voltage drop of the resistor with respect to a voltage of the external AC power.

2. The charging device according to claim 1, wherein
the charging circuit includes a smoothing capacitor, and
the control circuit performs control to cause the relay to be in the closed state after precharging the smoothing capacitor via the resistor.

3. The charging device according to claim 1, wherein
the external AC power is single-phase AC power, and
the control circuit interrupts the charging via the charging circuit when determining that the relay fails.

4. The charging device according to claim 1, wherein
the external AC power is three-phase AC power,
the inrush current prevention circuit, the voltage detector, and the charging circuit are provided for each phase, and
the control circuit determines a failure of the relay corresponding to each phase.

5. The charging device according to claim 4, wherein
the control circuit interrupts the charging via all of the charging circuit when determining that the relay corresponding to any of phases fails.

6. The charging device according to claim 4, wherein
when determining that the relay corresponding to any of the phases fails, the control circuit interrupts the charging via the charging circuit corresponding to the phase for which the relay is determined to fail and continues the charging via the charging circuit corresponding to the phase for which the relay is determined not to fail.

7. A method for controlling a charging device including: an inrush current prevention circuit for preventing an inrush current, the inrush current prevention circuit including a pair of input terminals to which external AC power is supplied, a resistor having a first end connected to a first input terminal of the input terminals, and a relay having a first end connected to the first input terminal of the input terminals, and a second end connected to a second end of the resistor; a voltage detector that detects a voltage between the second end of the resistor and a second input terminal of the input terminals; a control circuit that performs control of the relay based on the voltage of the voltage detector;
and a charging circuit that converts AC power supplied via the inrush current prevention circuit into DC power and performs charging of a secondary battery, wherein
the relay is in an open state in a state where power is not supplied to the input terminals, and
the method comprises:
detecting, by the voltage detector, a voltage after a predetermined time has elapsed since control to cause the relay to be in a closed state has been performed; and
determining that the relay fails when determining that the voltage detected by the voltage detector is a voltage corresponding to a voltage drop of the resistor with respect to a voltage of the external AC power.

8. A non-transitory computer-readable medium including programmed instructions that cause a computer to control a charging device including: an inrush current prevention circuit for preventing an inrush current, the inrush current prevention circuit including a pair of input terminals to which external AC power is supplied, a resistor having a first end connected to a first input terminal of the input terminals, and a relay having a first end connected to the first input terminal of the input terminals, and a second end connected to a second end of the resistor; a voltage detector that detects a voltage between the second end of the resistor and a second input terminal of the input terminals; a control circuit that performs control of the relay based on the voltage of the voltage detector; and a charging circuit that converts AC power supplied via the inrush current prevention circuit into DC power and performs charging of a secondary battery, wherein
the relay is in an open state in a state where power is not supplied to the input terminals, and
the programmed instructions cause the computer to:
detect, via the voltage detector, a voltage after a predetermined time has elapsed since control to cause the relay to be in a closed state has been performed; and
determine that the relay fails when determining that the voltage detected via the voltage detector is a voltage corresponding to a voltage drop of the resistor with respect to a voltage of the external AC power.
